(19) United States
(12) Patent Application Publication
(10) Pub. No.: US 2020/0382383 A1
(43) Pub. Date: Dec. 3, 2020

(54) ANALYSIS APPARATUS, COMMUNICATION SYSTEM, DATA PROCESSING METHOD, AND NON-TRANSITORY COMPUTER READABLE MEDIUM

(71) Applicant: NEC Corporation, Minato-ku, Tokyo (JP)

(72) Inventors: Daisuke YOKOI, Tokyo (JP); Tadashi ISHIKAWA, Tokyo (JP); Takuya ITOU, Tokyo (JP); Ichirou AKIMOTO, Tokyo (JP); Yoshinori KITAHARA, Tokyo (JP)

(73) Assignee: NEC Corporation, Minato-ku, Tokyo (JP)

(21) Appl. No.: 16/769,754

(22) PCT Filed: Dec. 4, 2018
(86) PCT No.: PCT/JP2018/044465

§ 371 Date: Jun. 4, 2020

(30) Foreign Application Priority Data
Dec. 7, 2017 (JP) 2017-235193

(51) Int. Cl. H04L 12/24; H04L 12/911; G06N 20/00

(52) U.S. Cl. CPC H04L 41/147; H04L 41/145; G06N 20/00; H04L 41/16; H04L 47/823; H04L 41/142

(57) ABSTRACT

An object of the present disclosure is to provide an analysis apparatus capable of solving a problem that the amount of data processing increases and the processing load thus increases. An analysis apparatus (10) according to the present disclosure includes: a prediction unit (13) configured to perform machine learning using past traffic data in a communication system to thereby predict future traffic data in the communication system; an analysis unit (11) configured to analyze the future traffic data using first input data and generate a first analysis result corresponding to a first purpose; and an analysis unit (12) configured to analyze the future traffic data using second input data and generate a second analysis result corresponding to a second purpose.

### TECHNICAL FIELD

The present disclosure relates to an analysis apparatus, a communication system, a data processing method, and a program.

### BACKGROUND ART

In recent years, a service for generating prediction data and the like by analyzing an enormous amount of data and providing the generated prediction data has been examined. For the analysis of an enormous amount of data, for example, machine learning is used. Data processing using machine learning is completed earlier than when a person performs data processing. Thus, by using machine learning or the like, it is possible to quickly process an enormous amount of data.

For example, Patent Literature 1 discloses an evaluation system that can determine the quality of the current facilities at a certain time point in the future while situations such as occurrences of failures that have not occurred so far and an increase in the number of users are assumed.

### CITATION LIST

### Patent Literature

Patent Literature 1: Japanese Unexamined Patent Application Publication No. 2009-212654

### SUMMARY OF INVENTION

### Technical Problem

The evaluation system disclosed in Patent Literature 1 predicts a traffic volume by a certain time point in the future and evaluates the quality of the current facilities at a certain time point in the future based on the predicted traffic volume. Patent Literature 1 discloses, for example, a series of data processing for evaluating the quality of the current facilities at a certain time point in the future, but fails to disclose that an evaluation system evaluates a plurality of items related to a network. Therefore, when an evaluation system for evaluating a plurality of items is constructed using the data processing disclosed in Patent Literature 1, it is necessary to perform processes, for each item, such as from a prediction of the traffic volume to a generation of the results of the evaluations corresponding to the items. Consequently, when the evaluation system evaluates a plurality of items, a problem occurs in which the amount of data processing increases in accordance with the number of items to be evaluated and the processing load on the evaluation system thus increases.

The present disclosure has been made in view of the aforementioned problem and an object thereof is to provide an analysis apparatus, a communication system, a data processing method, and a program that can solve a problem that the amount of data processing increases in accordance with the number of items to be evaluated and the processing load thus increases.

### Solution to Problem

An analysis apparatus according to a first aspect of the present disclosure includes:

a prediction unit configured to perform machine learning using past traffic data in a communication system to thereby predict future traffic data in the communication system;

a first analysis unit configured to analyze the future traffic data using first input data and generate a first analysis result corresponding to a first purpose; and

a second analysis unit configured to analyze the future traffic data using second input data and generate a second analysis result corresponding to a second purpose.

A communication system according to a second aspect of the present disclosure includes:

a communication apparatus;

an information accumulation apparatus configured to collect a communication log related to traffic data from at least the one communication apparatus; and

an analysis apparatus including a prediction unit configured to perform machine learning using the communication log to thereby predict future traffic data in the communication system that includes the communication apparatus, a first analysis unit configured to analyze the future traffic data using first input data and generate a first analysis result corresponding to a first purpose, and a second analysis unit configured to analyze the future traffic data using second input data and generate a second analysis result corresponding to a second purpose.

A data processing method according to a third aspect of the present disclosure includes:

performing machine learning using past traffic data in a communication system to thereby predict future traffic data in the communication system;

analyzing the future traffic data using first input data and generating a first analysis result corresponding to a first purpose; and

analyzing the future traffic data using second input data and generating a second analysis result corresponding to a second purpose.

A program according to a fourth aspect of the present disclosure causes a computer to perform the following processing of:

performing machine learning using past traffic data in a communication system to thereby predict future traffic data in the communication system;

analyzing the future traffic data using first input data and generating a first analysis result corresponding to a first purpose; and

analyzing the future traffic data using second input data and generating a second analysis result corresponding to a second purpose.

### Advantageous Effects of Invention

According to the present disclosure, it is possible to provide an analysis apparatus, a communication system, a data processing method, and a program that can solve a problem that the amount of data processing increases in accordance with the number of items to be evaluated and the processing load thus increases.

### BRIEF DESCRIPTION OF DRAWINGS

FIG. 1 is a configuration diagram of an analysis apparatus according to a first example embodiment;

FIG. 2 is a configuration diagram of a communication system according to a second example embodiment;

FIG. 3 is a configuration diagram of the analysis apparatus according to the second example embodiment;

FIG. 4 is a diagram for explaining an outline of processing performed by the analysis apparatus according to the second example embodiment;

FIG. 5 is a diagram for explaining a flow of data processing performed by the analysis apparatus according to the second example embodiment;

FIG. 6 is a diagram for explaining an outline of an analysis of an event according to the second example embodiment;

FIG. 7 is a diagram for explaining an outline of an analysis of a packet loss according to the second example embodiment;

FIG. 8 is a configuration diagram of the analysis apparatus according to a third example embodiment;

FIG. 9 is a configuration diagram of the analysis apparatus according to a third example embodiment; and

FIG. 10 is a configuration diagram of the analysis apparatus in each example embodiments.

### DESCRIPTION OF EMBODIMENTS

### First Example Embodiment

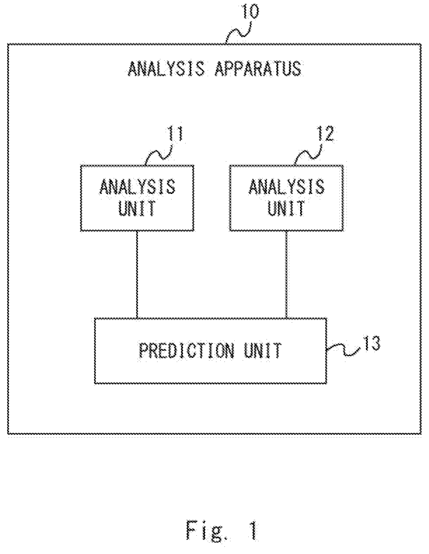

Hereinafter, with reference to the drawings, example embodiments of the present disclosure will be described. A configuration example of an analysis apparatus 10 according to a first example embodiment is described with reference to FIG. 1. The analysis apparatus 10 may be a computer apparatus that operates by a processor executing a program stored in a memory. The analysis apparatus 10 may be, for example, a personal computer or a server apparatus.

The analysis apparatus 10 includes an analysis unit 11, an analysis unit 12, and a prediction unit 13. Each of the analysis unit 11, the analysis unit 12, and the prediction unit 13 may be software or a module, the processing of which is performed by a processor executing a program stored in a memory. Alternatively, the analysis unit 11, the analysis unit 12, and the prediction unit 13 may be hardware such as chips or circuits.

The analysis unit 12 performs machine learning using past traffic data in a communication system to thereby predict traffic data in the communication system. The communication system includes, for example, a plurality of communication apparatuses or communication nodes. The communication system may be, for example, an access network system such as an optical communication network or a radio network. Alternatively, the communication system may be a backbone network system that relays data transmitted from the access network system. Alternatively, the communication system may be a system including the access network system and the backbone network system. The backbone network system may also be referred to as, for example, a core network system.

The traffic data may be, for example, data indicating the traffic volume or the amount of data transmitted between the communication apparatuses or in the communication system. The term “in the communication system” means the entire communication system including a plurality of communication apparatuses. For example, the traffic data between the communication apparatuses may be traffic data for each communication apparatus in the communication system. Further, the traffic data in the entire communication system may be the sum total of the traffic data between the communication apparatuses.

Alternatively, the traffic data may be the number of sessions configured or established between the communication apparatuses or in the communication system. Alternatively, the traffic data may be the number of communication terminals using the communication apparatus or the communication system. In other words, the traffic data may be the number of communication terminals connected to the communication apparatus or the communication system and may be the number of communication terminals managed in the communication apparatus or the communication system. Alternatively, the traffic data includes at least one of the traffic volume, the amount of data, the number of sessions, and the number of communication terminals, and may be data obtained by combining two or more elements among the traffic volume, the amount of data, the number of sessions, and the number of communication terminals. Further, the number of communication terminals may also be referred to as the number of users.

The past traffic data may be, for example, traffic data measured in a past specified period. Alternatively, the past traffic data may be traffic data predicted in a past specified period, and the predicted traffic data may be data modified or updated using the measured traffic data.

Performing machine learning to thereby predict traffic data may be, for example, the prediction unit 13 analyzing an enormous amount of past traffic data and predicting future traffic data using a specific pattern found as a result of the analysis. For example, the machine learning may be learning or generating a prediction model that calculates future traffic data as an objective variable using past traffic data as an explanatory variable. The prediction model may also be referred to as a prediction expression or a learning model. Further, the terms “presume” or “assume” may be used instead of “predict”. Further, the terms “compute” or “calculate” may be used instead of the term “predict”. The machine learning is a technique used to implement Artificial Intelligence (AI). Further, the machine learning may be specifically deep learning. The deep learning is, for example, learning using a neural network as a computational algorithm.

The analysis unit 11 analyzes future traffic data using a first input data. Further, the analysis unit 11 generates an analysis result corresponding to the purpose assigned to the analysis unit 11 or the purpose applied by the analysis unit 11. The first input data is input data required to generate an analysis result corresponding to the purpose assigned to the analysis unit 11 or the purpose applied by the analysis unit 11. That is, the first input data is data required to derive an analysis result generated by the analysis unit 11. The input data may also be referred to as, for example, auxiliary data. The purpose assigned to the analysis unit 11 or the purpose applied by the analysis unit 11 may also be referred to as, for example, a service provided by the analysis unit 11. Alternatively, the purpose may also be referred to as a policy.

The analysis unit 12 analyzes future traffic data using a second input data. Further, the analysis unit 12 generates an analysis result corresponding to the purpose assigned to the analysis unit 12 or the purpose applied by the analysis unit 12. The second input data is input data required to generate an analysis result corresponding to the purpose assigned to the analysis unit 12 or the purpose applied by the analysis unit 12. That is, the second input data is data required to derive an analysis result generated by the analysis unit 12.

The analysis unit 11 uses the same future traffic data as the future traffic data analyzed by the analysis unit 12. Further, the analysis unit 11 uses input data different from the input data used by the analysis unit 12, and generates an analysis result different from the analysis result generated by the analysis unit 12.

As described above, the analysis apparatus 10 can separately perform a prediction of the traffic data performed by the prediction unit 13 and an analysis of the predicted traffic data performed by the analysis units 11 and 12. Specifically, each of the analysis units 11 and 12 can generate an analysis result corresponding to the respective purposes by using the traffic data predicted by the prediction unit 13. That is, the analysis unit 11 can generate an analysis result different from the analysis result generated by the analysis unit 12 by using the same traffic data as the traffic data used by the analysis unit 12.

This configuration eliminates the need for each of the analysis units 11 and 12 to predict future traffic data using past traffic data. That is, in the analysis apparatus 10, the prediction unit 13 performs processing for predicting future traffic data using past traffic data, and the analysis units 11 and 12 use the traffic data predicted by the prediction unit 13. Thus, it is possible to prevent the processing for predicting future traffic data using past traffic data from being redundantly performed by the analysis units 11 and 12. Consequently, for example, even when the service provided by the analysis apparatus 10 increases and the number of analysis units increases, only the amount of analysis processing performed by each analysis unit increases, and thus it is possible to prevent the amount of processing for predicting traffic data from increasing.

### Second Example Embodiment

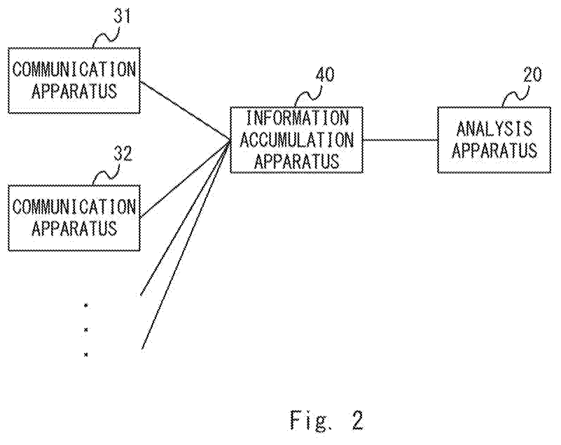

Next, a configuration example of a communication system according to a second example embodiment is described with reference to FIG. 2. The communication system shown in FIG. 2 includes an analysis apparatus 20, a communication apparatus 31, a communication apparatus 32, and an information accumulation apparatus 40. The analysis apparatus 20 corresponds to the analysis apparatus 10 shown in FIG. 1. The communication apparatuses 31 and 32 may also be referred to as communication nodes. The information accumulation apparatus 40 may be, for example, a database apparatus. Although FIG. 2 shows a configuration in which the communication system includes two communication apparatuses, the communication system may include three or more communication apparatuses. Further, the communication apparatuses 31 and 32 may be connected to another communication apparatus, respectively, via a wired line or a wireless line.

The communication apparatuses 31 and 32 may be, for example, base stations used in a mobile network, or may be core network apparatuses. The base station may be, for example, an evolved Node B (eNB) that supports Long Term Evolution (LTE) defined in the 3rd Generation Partnership Project (3GPP). Alternatively, the base station may be a Node B that supports the so-called 2G or 3G defined in the 3GPP.

The core network apparatus may be, for example, an apparatus that configures an Evolved Packet Core (EPC). The apparatus configuring the EPC may be, for example, a Mobility Management Entity (MME), a Serving Gateway (SGW), or a Packet Data Network Gateway (PGW).

Alternatively, the communication apparatuses 31 and 32 may be relay apparatuses that relay data transmitted between the base stations, between the core network apparatuses, or between the base station and the core network apparatus. The relay apparatus may be, for example, a transmission apparatus that configures a microwave radio communication system.

FIG. 2 shows the information accumulation apparatus 40 and the analysis apparatus 20 as separate apparatuses. However, the analysis apparatus 20 may be integrated with the information accumulation apparatus 40, for example, by causing the analysis apparatus 20 to include the function of the information accumulation apparatus 40.

The information accumulation apparatus 40 collects past traffic data from the communication apparatuses 31 and 32, and the like. The past traffic data collected by the information accumulation apparatus 40 may be, for example, communication logs generated in the communication apparatuses 31 and 32, and the like.

Further, the information accumulation apparatus 40 may include calendar information, information about events that have occurred, weather information, and information about campaigns that have been conducted (hereinafter collectively referred to as calendar information and the like). The information accumulation apparatus 40 may acquire the calendar information and the like, for example, from an external server. The calendar information includes date information, day-of-the-week information, holiday information, and the like. The information about events that have occurred may be, for example, information about sports events, information about implementation of elections, and the like. The information accumulation apparatus 40 may manage the past traffic data collected from the communication apparatuses 31 and 32 and the like, and the calendar information and the like in association with each other. Further, the traffic data associated with the calendar information and the like may be referred to as past traffic data.

The analysis apparatus 20 predicts future traffic data using the information accumulated in the information accumulation apparatus 40. Further, in place of the information accumulation apparatus 40, the analysis apparatus 20 may acquire the calendar information and the like, for example, from an external server. Alternatively, the analysis apparatus 20 may acquire calendar information different from the calendar information collected by the information accumulation apparatus 40 from an external server or the like. Further, the analysis apparatus 20 may generate an analysis result using the information accumulated in the information accumulation apparatus 40.

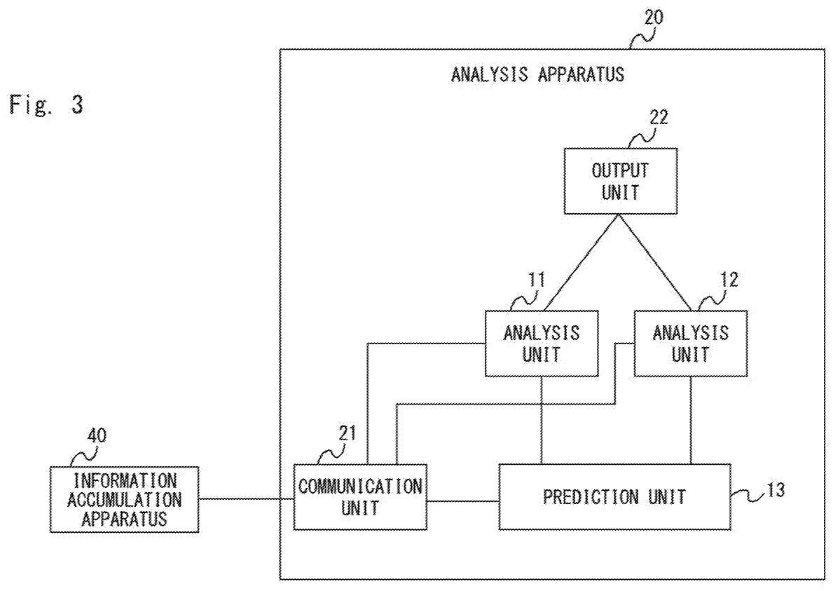

Next, a configuration example of the analysis apparatus 20 according to the second example embodiment is described with reference to FIG. 3. The configuration of the analysis apparatus 20 is the same as that of the analysis apparatus 10 shown in FIG. 1 except that a communication unit 21 and an output unit 22 are added. In the analysis apparatus 20, detailed descriptions of the same configuration or function as that of the analysis apparatus 10 are omitted.

The communication unit 21 communicates with the information accumulation apparatus 40. The communication unit 21 receives past traffic data from the information accumulation apparatus 40. Further, when the information accumulation apparatus 40 is integrated with the analysis apparatus 20, the communication unit 21 may collect past traffic data from the communication apparatuses 31 and 32, and the like.

The communication unit 21 outputs the received past traffic data to the prediction unit 13. Further, when the data received from the information accumulation apparatus 40 includes input data used by the analysis units 11 and 12, the communication unit 21 outputs the input data used by the analysis units 11 and 12 to the analysis units 11 and 12.

The prediction unit 13 predicts future traffic data using the past traffic data. It should be noted that the prediction unit 13 may predict traffic data to be processed by each communication apparatus such as the communication apparatuses 31 and 32. Alternatively, the prediction unit 13 may predict traffic data transmitted between the opposed communication apparatuses. Alternatively, the prediction unit 13 may predict traffic data transmitted in a communication section configured in three or more communication apparatuses. Alternatively, the prediction unit 13 may predict traffic data processed or transmitted in the entire communication system.

The analysis units 11 and 12 output the analysis results to the output unit 22, respectively. The output unit 22 outputs the analysis results received from the analysis units 11 and 12, for example, to a monitor. A user who manages or operates the analysis apparatus 20 can visually recognize the analysis results output to the monitor or the like. The monitor or the like may be configured integrally with the analysis apparatus 20 or may be a monitor apparatus connected to the analysis apparatus 20 via a cable, near field communication, or the like.

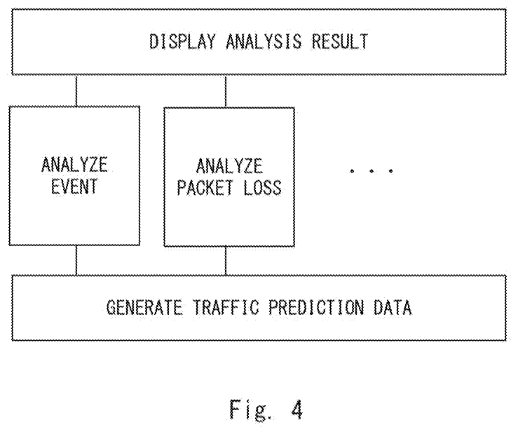

Next, an outline of the processing performed by the analysis apparatus 20 is described with reference to FIG. 4. The prediction unit 13 generates or calculates traffic prediction data using past traffic data. Further, the prediction unit 13 outputs the generated traffic prediction data to the analysis units 11 and 12. The traffic prediction data is data used in common by the analysis units 11 and 12.

For example, the analysis unit 11 analyzes an event using the traffic prediction data. The analysis unit 12 analyzes a packet loss using the traffic prediction data. Further, the analysis units 11 and 12 may perform other analyses. Further, the analysis apparatus 20 may include three or more analysis units, and other analyses may be performed in addition to the analysis of a packet loss and the analysis of an event. Examples of other analyses may include specifying, when a failure has occurred in the communication system, a method for dealing with the failure, and identifying, when a failure has occurred in the communication system, a cause of the failure.

The analysis units 11 and 12 may perform processing in an application layer. That is, the analysis units 11 and 12 may each be an application that provides a service.

Further, the analysis units 11 and 12 may perform processing using processors different from each other or may perform the processing using one processor. Further, the analysis units 11 and 12, and the prediction unit 13 may perform the processing using processors different from each other.

Further, the analysis unit 11 may analyze an event using a plurality of processors. That is, a plurality of processes included in the processing for analyzing an event may be performed by processors different from each other. The plurality of processes included in the processing for analyzing an event may be performed in parallel using the plurality of processors. Alternatively, the plurality of processes included in the process for analyzing an event may be performed in a stepwise manner using the processors connected in series. The same applies to the analysis of a packet loss performed by the analysis unit 12.

An analysis different from that mentioned above may be further performed using at least one of the result of the analysis of an event performed by the analysis unit 11 and the result of the analysis of a packet loss performed by the analysis unit 12. For example, the different analysis may be a traffic demand prediction or the like.

Further, the prediction unit 13 may predict future traffic data using a plurality of processors. That is, a plurality of processes included in the process for predicting future traffic data may be performed by processors different from each other. The plurality of processes included in the process for predicting future traffic data may be performed in parallel using the plurality of processors. Alternatively, a plurality of processes included in the process for predicting future traffic data may be performed in a stepwise manner using the processors connected in series.

The output unit 22 outputs the analysis results, each of which is respectively output from the analysis units 11 and 12, to a monitor or the like.

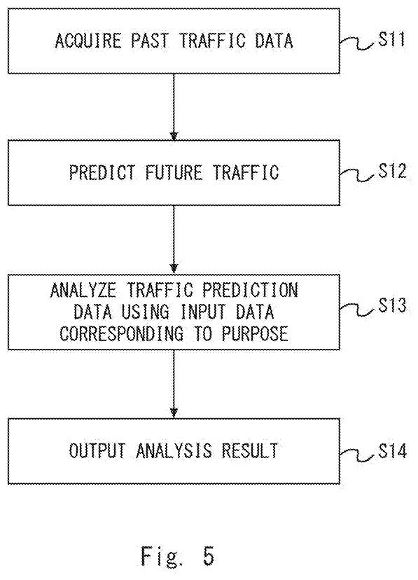

Next, a flow of the data processing performed by the analysis apparatus 20 is described with reference to FIG. 5. First, the prediction unit 13 acquires past traffic data from the information accumulation apparatus 40 via the communication unit 21 (S11). The past traffic data may be associated with calendar information and the like.

Next, the prediction unit 13 predicts future traffic data using the acquired past traffic data (S12). That is, the prediction unit 13 generates traffic prediction data. Next, the analysis units 11 and 12 analyze the traffic prediction data using input data corresponding to the purpose (S13). Next, the output unit 22 outputs the results of the analyses performed by the analysis units 11 and 12 to a monitor or the like.

A traffic prediction performed in Step S12 is described below in detail. The past traffic data acquired by the prediction unit 13 includes, for example, a traffic volume, an amount of data, the number of sessions, the number of communication terminals, and the like which have been actually measured in the past in each communication apparatus such as the communication apparatuses 31 and 32. Further, the past traffic data acquired by the prediction unit 13 includes calendar information and the like. That is, the prediction unit 13 uses at least one of the traffic volume, the amount of data, the number of sessions, and the number of communication terminals as an explanatory variable. Further, the prediction unit 13 also uses the calendar information and the like associated with at least one of the traffic volume, the amount of data, the number of sessions, and the number of communication terminals as an explanatory variable. At least one of the calendar information, the information about events that have occurred, the weather information, and the information about campaigns that have been conducted may be associated with the traffic volume and the like.

The prediction unit 13 calculates future traffic data, which is an objective variable, using a prediction expression used to perform a traffic prediction. The future traffic data includes, for example, at least one of the traffic volume, the amount of data, the number of sessions, and the number of communication terminals.

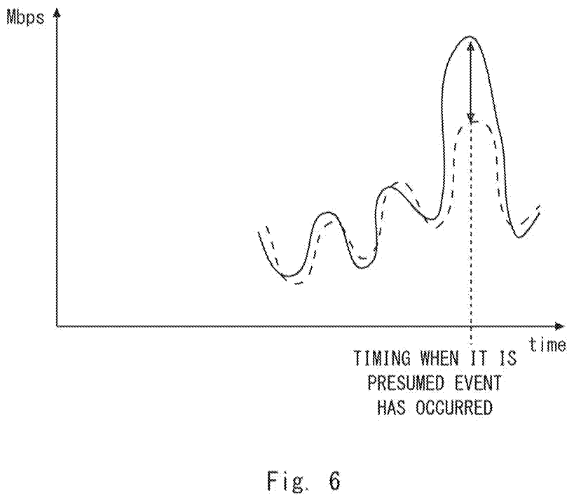

Next, an analysis of an event is described in detail as an example of an analysis performed by the analysis unit 11 with reference to FIG. 6. The analysis of an event may be, for example, analyzing whether an event has occurred using traffic prediction data and traffic measurement data. The event may be, for example, watching sports, an election, an occurrence of a disaster, or an occurrence of a failure. The traffic measurement data may be included, for example, in the past traffic data received from the information accumulation apparatus 40.

The analysis unit 11 acquires, from the information accumulation apparatus 40 via the communication unit 21, for example, the traffic measurement data in a part or the entire period of the traffic prediction data calculated by the prediction unit 13. That is, the analysis unit 11 uses, as input data, the traffic measurement data in a part or the entire period of the traffic prediction data calculated by the prediction unit 13. In FIG. 6, the vertical axis indicates an amount of traffic data in a predetermined period using Megabits per second (Mbps). Further, the horizontal axis indicates time. A curve indicated by a broken line indicates traffic prediction data. A curve shown by a solid line indicates traffic measurement data.

The analysis unit 11 compares the traffic prediction data with the traffic measurement data in the same period. The analysis unit 11 presumes that an event has occurred when the difference between the traffic prediction data and the traffic measurement data exceeds a predetermined threshold as a result of the comparison. Further, the analysis unit 11 may specify the content of the event that has occurred in accordance with the magnitude of the difference between the traffic prediction data and the traffic measurement data. For example, when the difference is larger than a Mbps (a is a positive value) and smaller than b Mbps (b is a positive value larger than a), the analysis unit 11 may determine that an event A has occurred. Further, when the difference is larger than b Mbps and smaller than c Mbps (c is a positive value larger than a), the analysis unit 11 may determine that an event B has occurred.

FIG. 6 shows the traffic prediction data and the traffic measurement data in the entire period of the traffic prediction data, but the traffic measurement data may be a part of the period of the traffic prediction data.

The threshold used to determine whether an event has occurred may be input, for example, by an administrator of the analysis apparatus 20 or a user thereof. Alternatively, the threshold used to determine whether an event has occurred may be calculated using statistical processing. For example, a standard deviation 6 of traffic measurement data with respect to traffic prediction data may be used as a threshold used to determine whether an event has occurred. Alternatively, a value obtained by multiplying the standard deviation 6 by a predetermined coefficient may be used as a threshold.

Alternatively, the analysis unit 11 may determine whether an event has occurred using machine learning. For example, the analysis unit 11 may use a prediction expression in which traffic prediction data and traffic measurement data are used as explanatory variables and the presence or absence of occurrence of events is used as an objective variable.

The result of the determination as to whether an event has occurred can be used in the future, for example, in order to discuss a configuration change in the communication system such as beefing up facilities when a similar event is likely to occur. That is, it can be considered that the result of the determination as to whether an event has occurred is information used to prompt a configuration change in the communication system.

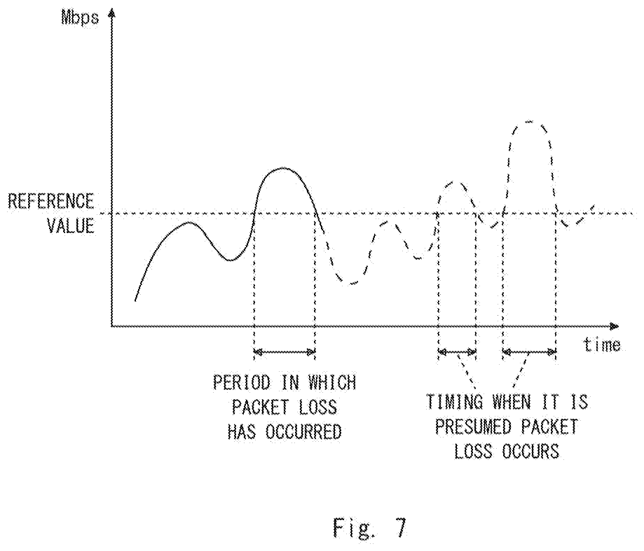

Next, an analysis of a packet loss is described in detail as an example of an analysis performed by the analysis unit 12 with reference to FIG. 7. The analysis of a packet loss may be, for example, predicting the occurrence time of a packet loss or the amount of a packet loss.

For example, the analysis unit 12 uses, as input data, data associating a period in which a packet loss has occurred in each of the communication apparatuses such as the communication apparatuses 31 and 32 with the amount of the traffic data in the period in which a packet loss has occurred. The analysis unit 12 may acquire input data used for an analysis from the information accumulation apparatus 40 via the communication unit 21. For example, the information accumulation apparatus 40 may collect, from each of communication apparatuses such as the communication apparatuses 31 and 32, information about a period in which a packet loss has occurred and the amount of traffic data in the period in which a packet loss has occurred as a communication log.

In FIG. 7, the vertical axis indicates an amount of traffic data in a predetermined period using Megabits per second (Mbps). Further, the horizontal axis indicates time. A curve indicated by a broken line indicates traffic prediction data. A curve indicated by a solid line indicates past traffic measurement data in a period before the period of the traffic prediction data.

Further, a reference value indicates the amount of traffic data at the timing when a packet loss has occurred in the past.

The analysis unit 12 compares the traffic prediction data with the reference value. The analysis unit 12 may predict, as a period in which a packet loss occurs, a period in which traffic exceeding a reference value is predicted to occur. In FIG. 7, two periods are predicted as periods in which a packet loss occurs. Further, the analysis unit 12 may predict the amount of a packet loss in a period in which the packet loss is predicted to occur based on the relation between the amount of the packet loss when the packet loss has occurred in the past and the amount of the traffic data. The analysis unit 12 may determine the relationship between the amount of the packet loss when the packet loss has occurred in the past and the amount of the traffic data using machine learning or the like.

As a reference value used to predict a period in which a packet loss occurs, for example, the standard deviation 6 related to the amount of the past traffic data calculated using statistical processing may be used. Alternatively, a value that is an integral multiple of the standard deviation 6 may be used as a threshold.

Alternatively, the analysis unit 12 may predict a period in which a packet loss occurs using machine learning. For example, the analysis unit 12 may use a prediction expression in which the amount of the past traffic data and the timing at which a packet loss has occurred are used as explanatory variables and the period in which a packet loss occurs is used as an objective variable.

The result of the determination regarding the period in which a packet loss occurs can be used in the future, for example, in order to discuss a configuration change in the communication system such as beefing up facilities or a change of the communication path before the period that is predicted as a period in which a packet loss occurs. That is, it can be considered that the result of the determination regarding the period in which a packet loss occurs is information used to prompt a configuration change in the communication system.

As described above, the analysis apparatus 20 according to the second example embodiment can generate or calculate traffic prediction data using the past traffic data collected by the information accumulation apparatus 40.

Further, the analysis units 11 and 12 can generate, using the traffic prediction data, results of the analyses such as the analysis of a packet loss and the analysis of an event. The prediction unit 13 can generate traffic prediction data used in common by the analysis units 11 and 12. Accordingly, neither of the analysis units 11 and 12 needs to generate traffic prediction data. This prevents the amount of processing of the traffic prediction data performed by the analysis apparatus 10 from increasing even when the number of analysis units or the number of results of the analyses to be generated increases.

### Third Example Embodiment

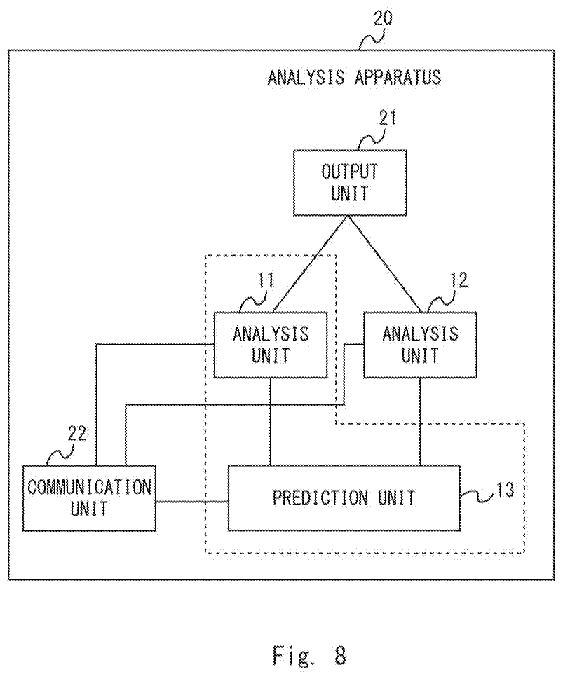

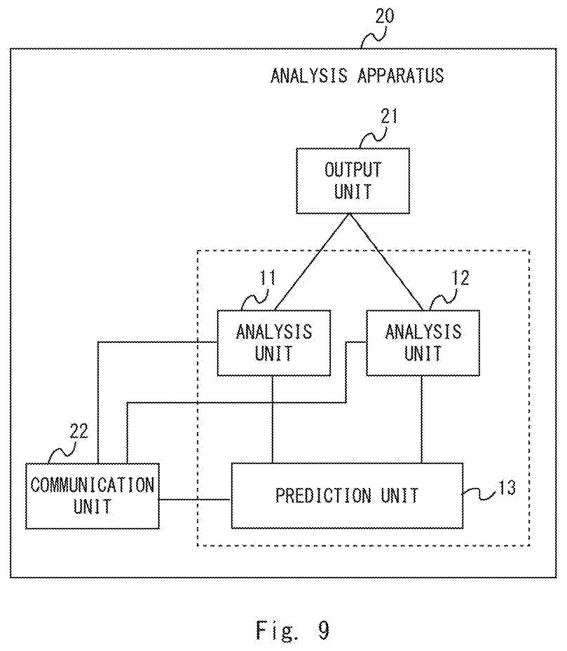

Next, a configuration example of the analysis apparatus 20 according to a third example embodiment is described with reference to FIGS. 8 and 9. A dotted line enclosing the analysis unit 11 and the prediction unit 13 in FIG. 8 indicates a range within which machine learning is performed. That is, FIG. 8 shows that the processing for predicting traffic data performed by the prediction unit 13 and the processing for an analysis performed by the analysis unit 11 are performed using machine learning. Further, FIG. 9 shows that the processing for predicting traffic data performed by the prediction unit 13 and the processing for an analysis performed by the analysis units 11 and 12 are performed using machine learning. That is, all the processes for the analysis may be performed using machine learning.

Alternatively, all the processes for the analysis may be performed without using machine learning.

When machine learning is used, the amount of prediction data and the amount of input data used to generate an analysis result can be increased more than when machine learning is not used. Therefore, it is possible to increase the accuracy of the analysis result when machine learning is used more than when machine learning is not used.

Further, when machine learning is not used, for example, there are a case in which an administrator or the like determines a criterion for determination and a case in which a criterion for determination is determined using statistical processing. When a criterion for determination is determined using statistical processing, it is possible to determine a criterion for determination using an amount of past traffic data and the like larger than that used when an administrator or the like determines a criterion for determination. Thus, it is possible to increase the accuracy of the analysis result when a criterion for determination is determined using statistical processing more than when an administrator or the like determines a criterion for determination.

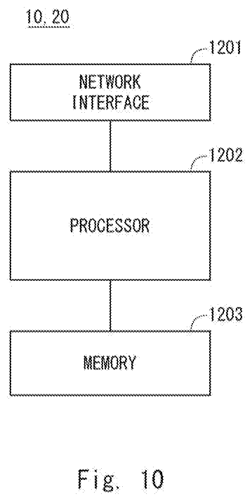

FIG. 10 is a configuration diagram of the analysis apparatus 10 or 20 described in the above example embodiments. Referring to FIG. 10, it is seen that the analysis apparatus 10 or 20 includes a network interface 1201, a processor 1202, and a memory 1203. The network interface 1201 is used to communicate with another network node apparatus that configures a communication system. The network interface 1201 may include, for example, a network interface card (NIC) conforming to the IEEE 802.3 series.

The processor 1202 loads software (computer programs) from the memory 1203 and executes the loaded software (computer programs) to perform processing of the analysis apparatus 10 or 20 described with reference to the sequence diagrams and the flowcharts in the above example embodiments. The processor 1202 may be, for example, a microprocessor, a Micro Processing Unit (MPU), or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an I/O interface (not shown).

In the example shown in FIG. 10, the memory 1203 is used to store software modules. The processor 1202 may load these software modules from the memory 1203 and execute the loaded software modules, thereby performing the processing of the analysis apparatus 10 or 20 described in the above example embodiments.

As described with reference to FIG. 10, each of the processors included in the analysis apparatus 10 or 20 executes one or a plurality of programs including instructions to cause a computer to perform the algorithm described with reference to the drawings.

In the above examples, the program(s) can be stored and provided to a computer using any type of non-transitory computer readable media. Non-transitory computer readable media include any type of tangible storage media. Examples of non-transitory computer readable media include magnetic storage media (e.g., flexible disks, magnetic tapes, and hard disk drives), optical magnetic storage media (e.g., magneto-optical disks). Further, examples of non-transitory computer readable media include CD-ROM (Read Only Memory), CD-R, and CD-R/W. Further, examples of non-transitory computer readable media include semiconductor memories. The semiconductor memories include, for example, mask ROM, PROM (Programmable ROM), EPROM (Erasable PROM), flash ROM, RAM (Random Access Memory), etc. Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and can be modified as appropriate without departing from the spirit of the present disclosure. Further, the present disclosure may be executed by combining the example embodiments as appropriate.

While the present invention has been described with reference to the example embodiments, the present invention is not limited to the aforementioned example embodiments. Various changes that can be understood by those skilled in the art can be made to the configurations and the details of the present invention within the scope of the present invention.

This application is based upon and claims the benefit of priority from Japanese patent application No. 2017-235193, filed on Dec. 7, 2017, the disclosure of which is incorporated herein in its entirety by reference.

Further, the whole or part of the example embodiments disclosed above can be described as, but not limited to, the following supplementary notes.

(Supplementary Note 1)

An analysis apparatus comprising:

a prediction unit configured to perform machine learning using past traffic data in a communication system to thereby predict future traffic data in the communication system;

a first analysis unit configured to analyze the future traffic data using first input data and generate a first analysis result corresponding to a first purpose; and

a second analysis unit configured to analyze the future traffic data using second input data and generate a second analysis result corresponding to a second purpose.

(Supplementary Note 2)

The analysis apparatus described in Supplementary Note 1, wherein the prediction unit calculates the future traffic data used in common by the first and the second analysis units, and outputs the calculated future traffic data to the first and the second analysis units.

(Supplementary Note 3)

The analysis apparatus described in Supplementary Note 1 or 2, wherein

the first analysis unit performs machine learning using the first input data and the future prediction data to thereby calculate the first analysis result, and

the second analysis unit performs machine learning using the second input data and the future prediction data to thereby calculate the second analysis result.

(Supplementary Note 4)

The analysis apparatus described in Supplementary Note 1 or 2, wherein

the first analysis unit performs machine learning using the first input data and the future prediction data to thereby calculate the first analysis result, and

the second analysis unit generates the second analysis result in accordance with a predetermined criterion for determination.

(Supplementary Note 5)

The analysis apparatus described in Supplementary Note 4, wherein the criterion for determination is determined by performing statistical processing on the past traffic data.

(Supplementary Note 6)

The analysis apparatus described in any one of Supplementary Notes 1 to 5, wherein each of the first and the second analysis results is information used to prompt a configuration change of the communication system.

(Supplementary Note 7)

The analysis apparatus described in any one of Supplementary Notes 1 to 6, wherein at least one of the first input data and the second input data includes traffic data measured in the same period as a part or an entire period of a predicted period of the future traffic data.

(Supplementary Note 8)

The analysis apparatus described in any one of Supplementary Notes 1 to 7, wherein the second analysis unit generates the second analysis result in accordance with the criterion for determination that has been used when the second analysis result has been generated in the past.

(Supplementary Note 9)

A communication system comprising:

a communication apparatus;

an information accumulation apparatus configured to collect a communication log related to traffic data from at least the one communication apparatus; and

an analysis apparatus comprising a prediction unit configured to perform machine learning using the communication log to thereby predict future traffic data in the communication system that comprises the communication apparatus, a first analysis unit configured to analyze the future traffic data using first input data and generate a first analysis result corresponding to a first purpose, and a second analysis unit configured to analyze the future traffic data using second input data and generate a second analysis result corresponding to a second purpose.

(Supplementary Note 10)

The communication system described in Supplementary Note 9, wherein the prediction unit calculates the future traffic data used in common by the first and the second analysis units, and outputs the calculated future traffic data to the first and the second analysis units.

(Supplementary Note 11)

The communication system described in Supplementary Note 9 or 10, wherein

the first analysis unit performs machine learning using the first input data and the future prediction data to thereby calculate the first analysis result, and

the second analysis unit performs machine learning using the second input data and the future prediction data to thereby calculate the second analysis result.

(Supplementary Note 12)

The analysis apparatus described in Supplementary Note 9 or 10, wherein

the first analysis unit performs machine learning using the first input data and the future prediction data to thereby calculate the first analysis result, and

the second analysis unit generates the second analysis result in accordance with the second input data, the future prediction data, and a predetermined criterion for determination.

(Supplementary Note 13)

A data processing method comprising:

performing machine learning using past traffic data in a communication system to thereby predict future traffic data in the communication system;

analyzing the future traffic data using first input data and generating a first analysis result corresponding to a first purpose; and

analyzing the future traffic data using second input data and generating a second analysis result corresponding to a second purpose.

(Supplementary Note 14)

A program causing a computer to execute the following processing of:

performing machine learning using past traffic data in a communication system to thereby predict future traffic data in the communication system;

analyzing the future traffic data using first input data and generating a first analysis result corresponding to a first purpose; and

analyzing the future traffic data using second input data and generating a second analysis result corresponding to a second purpose.

### REFERENCE SIGNS LIST

10 ANALYSIS APPARATUS
11 ANALYSIS UNIT
12 ANALYSIS UNIT
13 PREDICTION UNIT
20 ANALYSIS APPARATUS
21 COMMUNICATION UNIT
22 OUTPUT UNIT
31 COMMUNICATION APPARATUS
32 COMMUNICATION APPARATUS
40 INFORMATION ACCUMULATION APPARATUS

What is claimed is:

1. An analysis apparatus comprising:
at least one memory storing instructions, and
at least one processor configured to execute the instructions to;
perform machine learning using past traffic data in a communication system to thereby predict future traffic data in the communication system;
analyze the future traffic data using first input data and generate a first analysis result corresponding to a first purpose; and
analyze the future traffic data using second input data and generate a second analysis result corresponding to a second purpose.

2. The analysis apparatus according to claim 1, wherein the at least one processor is further configured to execute the instructions to calculate the future traffic data used in common when the future traffic data using first input data and the future traffic data using second input data are analyzed, and output the calculated future traffic data.

3. The analysis apparatus according to claim 1, wherein the at least one processor is further configured to execute the instructions to perform machine learning using the first input data and the future prediction data to thereby calculate the first analysis result, and
perform machine learning using the second input data and the future prediction data to thereby calculate the second analysis result.

4. The analysis apparatus according to claim 1, wherein the at least one processor is further configured to execute the instructions to perform machine learning using the first input data and the future prediction data to thereby calculate the first analysis result, and
generate the second analysis result in accordance with a predetermined criterion for determination.

5. The analysis apparatus according to claim 4, wherein the criterion for determination is determined by performing statistical processing on the past traffic data.

6. The analysis apparatus according to claim 1, wherein each of the first and the second analysis results is information used to prompt a configuration change of the communication system.

7. The analysis apparatus according to claim 1, wherein at least one of the first input data and the second input data includes traffic data measured in the same period as a part or an entire period of a predicted period of the future traffic data.

8. The analysis apparatus according to claim 1, wherein the at least one processor is further configured to execute the instructions to generate the second analysis result in accordance with the criterion for determination that has been used when the second analysis result has been generated in the past.

9. A communication system comprising:
a communication apparatus;
an information accumulation apparatus; and
an analysis apparatus;
wherein the information accumulation apparatus comprises;
at least one memory storing instructions, and
at least one processor configured to execute the instructions to;
collect a communication log related to traffic data from at least the one communication apparatus;
wherein the analysis apparatus comprises;
at least one memory storing instructions, and
at least one processor configured to execute the instructions to;
perform machine learning using the communication log to thereby predict future traffic data in the communication system that comprises the communication apparatus, analyze the future traffic data using first input data and generate a first analysis result corresponding to a first purpose, and analyze the future traffic data using second input data and generate a second analysis result corresponding to a second purpose.

10. The communication system according to claim 9, wherein the at least one processor of the analysis apparatus is further configured to execute the instructions to calculate the future traffic data used in common when the future traffic data using first input data and the future traffic data using second input data are analyzed, and output the calculated future traffic data.

11. The communication system according to claim 9, wherein the at least one processor of the analysis apparatus is further configured to execute the instructions to perform machine learning using the first input data and the future prediction data to thereby calculate the first analysis result, and
perform machine learning using the second input data and the future prediction data to thereby calculate the second analysis result.

12. The analysis apparatus according to claim 9, wherein the at least one processor of the analysis apparatus is further configured to execute the instructions to perform machine learning using the first input data and the future prediction data to thereby calculate the first analysis result, and
generate the second analysis result in accordance with the second input data, the future prediction data, and a predetermined criterion for determination.

13. A data processing method comprising:
performing machine learning using past traffic data in a communication system to thereby predict future traffic data in the communication system;
analyzing the future traffic data using first input data and generating a first analysis result corresponding to a first purpose; and
analyzing the future traffic data using second input data and generating a second analysis result corresponding to a second purpose.

14. A non-transitory computer readable medium storing a program for causing a computer to execute the following processing of:
performing machine learning using past traffic data in a communication system to thereby predict future traffic data in the communication system;
analyzing the future traffic data using first input data and generating a first analysis result corresponding to a first purpose; and
analyzing the future traffic data using second input data and generating a second analysis result corresponding to a second purpose.
